(19) United States
(12) Patent Application Publication
(10) Pub. No.: US 2007/0290601 A1
(43) Pub. Date: Dec. 20, 2007

(54) Electron-emitting source and field emission display using the same

(75) Inventors: Jason Lo, Taipei City (TW); Jian-Min Jeng, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/651,478

(22) Filed: Jan. 10, 2007

(30) Foreign Application Priority Data
Jun. 19, 2006 (TW) 095121847

(51) Int. Cl. H01J 63/04; H01J 1/62

(52) U.S. Cl. 313/496

(57) ABSTRACT

An electron emission source and a field emission device using the same. The diamond-like carbon (DLC) film used as the electron emission source is featured by its film structures formed on the substrate surface arranged in a petal pattern. The height of the DLC flake is in micro scale and the thickness of the flake is in nano scale. The disclosed DLC flake film has a high aspect ratio. Hence, the DLC film has a good enhancing factor favorable for field emission, acting as a good electron-emitting source. In addition, the electron-emitting source material disclosed can be applied in a field emission display to act as a stable electron-emitting source.

### BACKGROUND OF THE INVENTION

1. Field of the Invention

The present invention relates to an electron-emitting source. More particularly, the present invention relates to a field emission display with an electron-emitting source.

2. Description of Related Art

Display devices have become essential in our daily lives. Aside from use in PC systems or to browse the Internet, display devices are also found in TVs, mobile phones, PDAs (Personal Digital Assistant), and digital cameras for visual presentation of images and text. Compared to traditional cathode ray tubes, the newer flat panel displays have the advantages of being lightweight, compact size, and less harmful to human health.

Among the emerging flat panel display technologies, FEDs (Field Emission Display) appear to be the most promising display technique. FEDs. Aside from coming into the same high display resolutions enjoyed by traditional CRTs (cathode ray tubes,) they also do not inherit the drawbacks of LCDs (Liquid Crystal Displays) of narrow viewing angle, small operating temperature range, and slow response time. That is, FEDs have the advantages of high luminescent efficiency, fast response time, good display coordination, high luminance exceeding 100 ftL, structural compactness, wide viewing angle, large operating temperature range, and high working efficiency.

Another reason for the optimistic outlook for FEDs lies in their operation without the need for backlight modules. Even in outdoor sunny environments, FEDs still perform well in the brightness category. For that reason, FEDs are already regarded as competing with LCDs in becoming the dominant display technology, and expected to replace LCDs in that respect.

The FEDs operate similar to CRTs under vacuum environments with pressure of less than 10⁻⁶ torr, under which electrons on the tip of the cathode are pulled out using an electric field. Then, under the acceleration by the positive voltage of the anode, the electrons impinge on the phosphor powder on the anode plate to create luminescence. Typically, FEDs are to control the variation of the voltage difference applied between the anode and the cathode, and to cause each electron-emitting source to emit electrons at a prescribed time.

To satisfy the need for field emitter cathode, the work function and geometric construction of the field emitter cathode are ideally as small as possible. Given the short life span and manufacturing difficulty in prior art metal-coned electron-emitting elements, current research done on the material used for electron-emitting sources of FEDs is primarily focused on the type of carbon with chemical stability, electrical conductivity, or low electron affinity. More specifically, the preferred carbon material includes amorphous carbon films, diamond films, diamond-like carbon films, and carbon nanotubes.

Due to the structural nature of high aspect ratio, carbon nanotubes have low threshold voltage and high current emission density, i.e., good field enhancement factor, thus making carbon nanotubes a popular field emission material.

However, carbon nanotubes are not without shortcomings. The nano-scale nature in structure makes distributing the carbon nanotubes evenly in the electron-emitting source slurry difficult, giving uneven current distribution and reducing operating life span. Also, the large surface area of carbon nanotubes also gives rise to its instability. Hence, there is a need for surface modification to the carbon nanotubes in order to improve field emission stability.

Diamond-like carbon is primarily composed of amorphous carbon with Sp³ three-dimensional and Sp² planar structures. Sp³ structure has lower electron affinity and stronger mechanical properties, and Sp² structure has better conductive property; therefore, the DLC formed with these two structures enjoys the benefits of both low electron affinity and conductive properties.

It is therefore necessary to provide a diamond-like carbon electron emission material with good field enhancement factor that not only has high aspect ratio in structure, but also has low electron affinity. Also, DLC has stable material properties that are favorable for the later manufacturing process of elements to become good electron emission material.

### SUMMARY OF THE INVENTION

The object of the present invention is to provide an electron-emitting source that uses a DLC film layer with a film structure as the material for electron emission. Since the film structures of the DLC film of the present invention have heights in micro-scale dimensions, and thickness in nano-scale dimensions, the film structures of the DLC film of the invention have the advantage of high aspect ratio.

The invention achieves the object by providing an electron-emitting source, including a substrate and a DLC film layer with film structures deposited on the surface of the substrate. The film structures of the DLC film layer are arranged on the surface of the substrate to form a petal pattern, and the lateral height of the film structure is between 0.5 μm and 4.0 μm.

The invention achieves the object by further providing an electron-emitting source that includes a substrate, a conductive layer formed on the surface of the substrate, and a DLC film layer with film structures deposited on the surface of the substrate. The film structures of the DLC-film layer are arranged on the surface of the substrate to form a petal pattern, and the lateral height of the film structure is between 0.5 μm and 4.0 μm.

The invention achieves the object by further providing a field emission display that includes an upper substrate having a phosphor layer and an anode layer, and a lower substrate having an electron emission layer and a cathode layer. The electron emission layer is closely adhered, and electrically connected, to the cathode layer.

In the structural configuration of the invention, the film structures of the DLC layer have a lateral height between 0.5 μm and 4.0 μm, and preferably between 0.9 μm and 2.0 μm. The thickness of the film structures is not limited, but is preferably between 0.005 μm and 0.1 μm, and more preferably between 0.005 μm and 0.05 μm.

In the embodiments of the invention, the substrate material is preferably, but not limited to, semiconductor material or glass material.

In a preferred embodiment of the invention, when the substrate is constituted of glass material, the surface of the glass substrate is coated with a conductive layer to allow the film structures of the DLC film layer to form on the conduction layer surface. Thereby, the invention can through the conductive layer provide a current to the film structures of the DLC film layer for electron emitting.

In another preferred embodiment of the invention, the suitable material for the substrate of the electron emitter is semiconductor. Since the substrate material is conductive by nature, the film structures of the DLC film layer can be directly formed on the surface of the substrate to form an electron-emitting source. Also, the conduction layer can be of any conductive material, preferably of ITO (Indium Tin Oxide), zinc oxide, ZTO (Zinc Tin Oxide), or metal material.

The film structures of the DLC film layer of the electron-emitting source are preferably, not but limited to, long-strip film structures or curved film structures. The primary appeal of the film structures is the high aspect ratio, which allows the DLC film layer of the invention to have a great film enhancement factor and low electron affinity ideal for a good electron-emitting source. Also, in the field emission display of the invention, the micro-scale film structures of the DLC are stable and can be a good material ideal for electron emission without any surface modification.

The electron-emitting source of the invention can be applied in any technology field requiring electron emission, preferably in cold cathode emitters such as field emission elements, field emission displays, or flat panel light sources.

The field emission display of the invention further includes a gate electrode layer disposed between the upper substrate and the lower substrate. The gate electrode layer can be any gate electrode traditionally used in field emission displays, and is preferably a ring-shaped gate electrode. Through such, the gate electrode layer allows every electron-emitting source to accurately emit electrons at prescribed times.

The upper substrate of the field emission display of the invention can further include a photo-mask layer. The photo-mask layer can be disposed adhering closely to the side of the phosphor layer to mask off leaking light and increase picture contrast.

Compared to traditional carbon nanotubes material, the micro-scaled film structures of the DLC used by the invention requires a relatively lower temperature for growth process, and can be directly grown on the glass substrate surface, which are factors favorable for fabrication. At the same time, DLC film can be deposited on the surface of the substrate using sputtering process, allowing a large area to be manufactured to reduce the time for preparation and manufacturing costs.

Other objects, advantages, and novel features of the invention will become more apparent from the following detailed description when taken in conjunction with the accompanying drawings.

### BRIEF DESCRIPTION OF THE DRAWINGS

FIG. 1 is a schematic of a sputtering reaction chamber used for depositing the DLC film layer according to a preferred embodiment of the invention;

FIG. 2a is an SEM (Scanning Electron Microscope) diagram illustrating a top view of the substrate deposited with a DLC film layer on surface according to a preferred embodiment of the invention;

FIG. 2b is an SEM (Scanning Electron Microscope) diagram illustrating side view of the substrate deposited with a DLC film layer on surface according to a preferred embodiment of the invention;

FIG. 3 is a schematic illustrating the diode configuration used for testing field emission effects according to a preferred embodiment of the invention;

FIG. 4 is a Raman plot of the DLC film layer made in embodiments 3 to 7;

FIG. 5 is a plot of the results of the diode field emissions tests of the substrate with DLC film layer made in embodiments 3 to 7; and

FIG. 6 is a plot of the result of the triode field emission test of the substrate with DLC film layer made in embodiment 6.

### DETAILED DESCRIPTION OF THE PREFERRED EMBODIMENT

### Embodiment 1

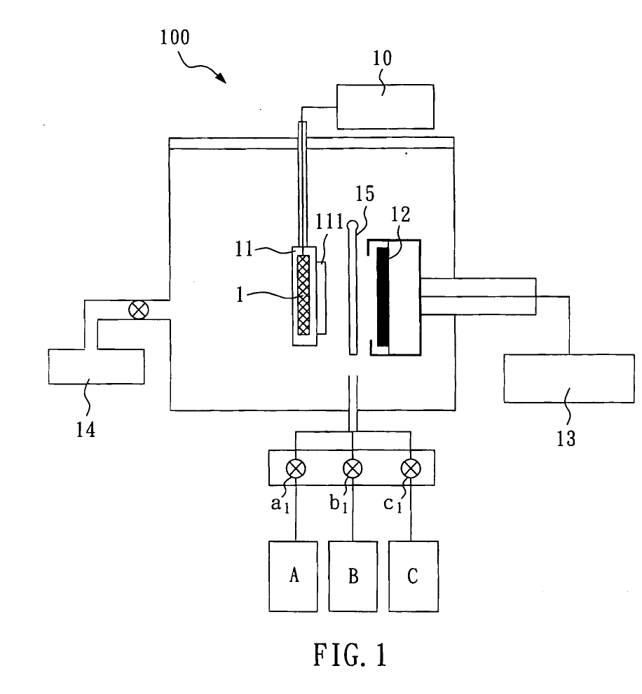

Below, a DLC film layer fabrication process according to a preferred embodiment of the invention is described. FIG. 1 is a schematic of a sputtering reaction chamber 100 used for depositing the DLC film layer according to a preferred embodiment of the invention.

First, a reaction chamber 100 for sputtering is provided. Reaction chamber 100 includes a heater 10 and lamp 1 for heating substrate 111, a load platform 11 for supporting substrate 111, a power supply 13 for applying voltage on target material 12, and a plurality of gas supply units A, B, and C for supplying reactant gas. It is noted that during the formation of the DLC film layer, the quantity of gas supply units can be increased or decreased depending on the gas conditions required for the process.

Then, the surface of substrate 111 is cleaned and substrate 111 is disposed on load platform 11 in reaction chamber 100. In this embodiment, the substrate 111 is a semiconductor silicon wafer. Then, a vacuum pump device 14 removes air from the reaction chamber 100 to result in a pressure of under 1×10⁻⁵ torr, and lamp 1 heats substrate 111 to a temperature of 400° C.

Then, the gases required for reaction are supplied by gas supply units A, B, C into reaction chamber 100, and the flow rates of each of the gases into which are controlled by a mass flow controller (not shown). The gas supply units A, B, C in the embodiment are gas supply sources containing argon, methane, and hydrogen respectively. The determination of whether the three gases are bled into the reaction chamber 100 is based on the manufacturing conditions, and the flow of the gases is regulated by the gas supply valves a1, b1 and c1. In this embodiment, the gases bled into reaction chamber 100 contain argon, methane and hydrogen, with a gas ratio of 2:1:1.

In this embodiment, when the reactant gases are bled into reaction chamber 100, the internal pressure is controlled to 9×10⁻³ torr. In other embodiments, the pressure for sputtering reaction can take on different values adjustable upon manufacturing needs.

Thereafter, graphite target material 12 is pre-sputtered for 30 minutes with 200 W of RF power to remove possible pollutants from the surface of target material 12 as the shutter 15 is closed. Then, the shutter 15 is opened and the surface of substrate 111 undergoes sputtering for 70 minutes to grow a DLC layer on substrate surface.

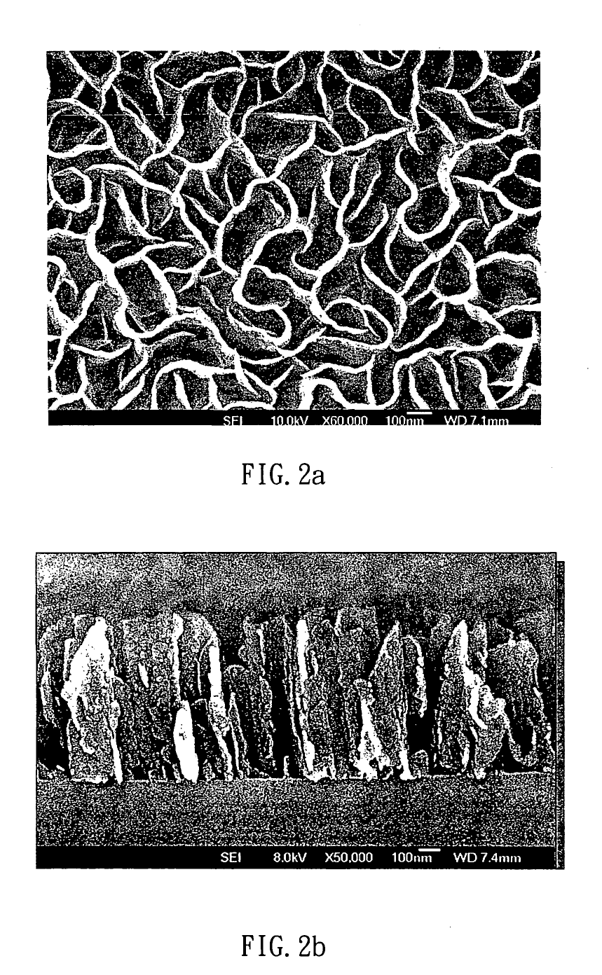

FIG. 2a and 2b respectively show SEM (Scanning Electron Microscope) diagrams of the front view and side view of the substrate deposited with DLC film layer on surface according to a preferred embodiment of the invention.

As shown in FIG. 2a and 2b, the DLC film layer made in this embodiment is a curved film structure or a long-strip film structure. The film structures are arranged in a three-dimensional petal pattern on the surface of substrate 111. Preferably, the average height of the film structures in this embodiment is 1 μm, and the average thickness of the films structures is between 10 nm and 20 nm.

Hence, this DLC layer made in this embodiment has the feature of high aspect ratio, and the substrate used in the embodiment is a conductive material, i.e., semiconductor, and thus can be directly used as an electron-emitting source.

### Embodiment 2

Field Emission Test:

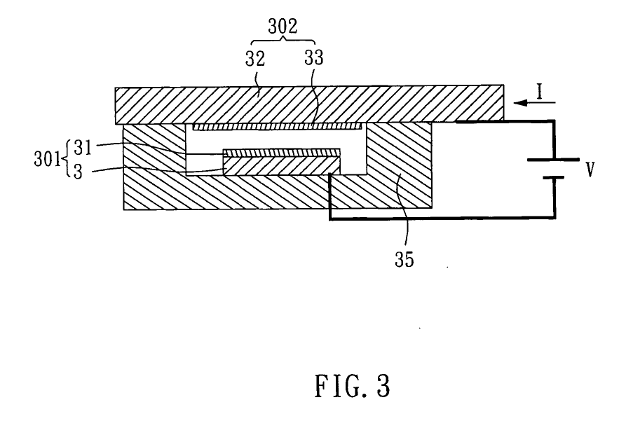

In this embodiment, substrate 1 with DLC layer is cut into test films 3 with dimensions of 8×8 mm for field emission testing. FIG. 3 shows a schematic illustrating the diode configuration used for testing field emission effects according to the present embodiment of the invention. In the field emission test of this embodiment, a test film 3 with DLC film layer 31 is used as a cathode plate 301, and an ITO glass substrate 32 with a luminance layer 33 is used as an anode plate 302. In this embodiment, the luminance layer 33 is a phosphor layer, and the ITO glass substrate 32 is a glass substrate having an ITO (Indium-Tin Oxide) layer that acts as the anode layer (not shown).

First, cathode plate 301 is emplaced in a notch 35, and above of which is covered with anode plate 302. Notch 35 is then placed inside the vacuum chamber and the pressure is reduced to below 1×10⁻⁶ torr. A voltage is applied between the two electrodes 302 and 302 for measuring the magnitude of the current produced by the electron-emitting source of cathode plate 301.

### Embodiment 3 to Embodiment 7

The DLC film layer in embodiments 3 to 7 are made in the same steps, process and under the same parameters as described in embodiment 1, except for the difference in the gas used during sputtering. The different ratios of hydrogen introduced in different embodiments are for controlling the density of the film structures of the DLC film.

Table 1 illustrates the different gas ratios used in embodiments 3 to 7.

TABLE 1

| | Argon | Methane | Hydrogen |
|---|---|---|---|
| Embodiment 3 | 8 | 8 | 8 |
| Embodiment 4 | 10 | 5 | 5 |
| Embodiment 5 | 10 | 5 | 2 |
| Embodiment 6 | 16 | 8 | 0 |
| Embodiment 7 | 16 | 4 | 0 |

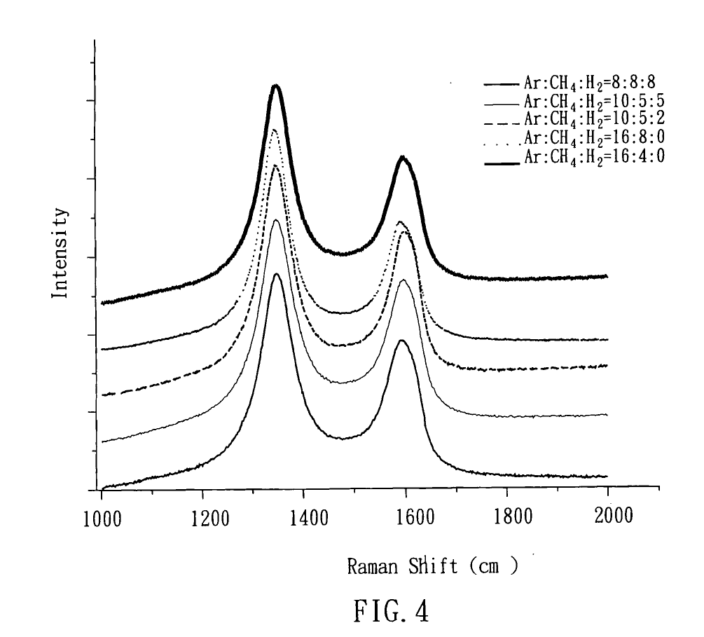

FIG. 4 is a Raman spectrum of the DLC film layer made in embodiments 3 to 7. As can be seen from FIG. 4, the DLC layer made by the invention is primarily composed three-dimensional SP³ and planar Sp² structures, and thus has a tetrahedral diamond structure with an approximate absorption peak of 1332 cm⁻¹, and planar graphic structure with an approximate absorption peak of 1580 cm⁻¹.

### Embodiment 8

Field Emission Test:

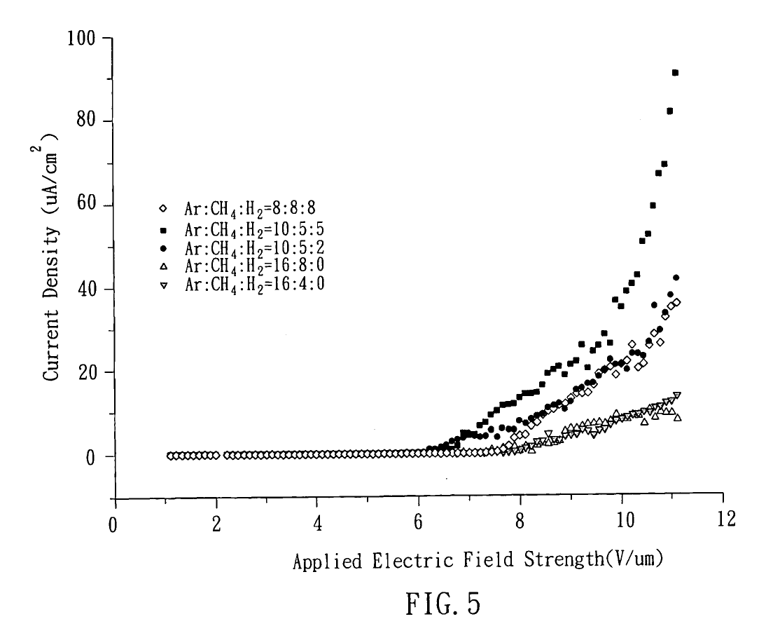

The substrate with a DLC layer made in embodiments 3 to 7, like embodiment 1, also entail the diode configuration for field emission testing, and the results of which are indicated in FIG. 5.

In FIG. 5, the x-axis is the electric field strength (V/μm) applied between the two electrode plates, and the y-axis is the density of the current emitted by DLC layer (μA/cm²). As shown by the results, increasing the concentration of the hydrogen for carbon films etching during the sputtering process results in the formation of less compactly arranged film structures, which have better field emission effects.

### Embodiment 9

In this embodiment, the surface of the lower substrate of the field emission display includes a molybdenum/titanium metal layer that acts as a cathode layer. The material of the substrate used in this embodiment is glass. Also, the surface of the cathode layer in this embodiment includes a patterned insulating layer and gate electrode layer to partially expose the surface of the cathode. The insulating layer is disposed between the cathode layer and the gate electrode layer to provide electrical insulation.

The above-mentioned lower substrate structure is placed in a sputtering reaction chamber, and undergoes the sputtering reaction as described in the embodiment 1 so as to grow an electron emission layer with a DLC film layer on the exposed cathode surface. Lastly, the DLC film layer deposited on the surface of the gate electrode is removed to obtain the lower substrate of the field emission display of the present embodiment. The structural characteristic of the DLC film layer in this embodiment is similar to that of embodiment 1.

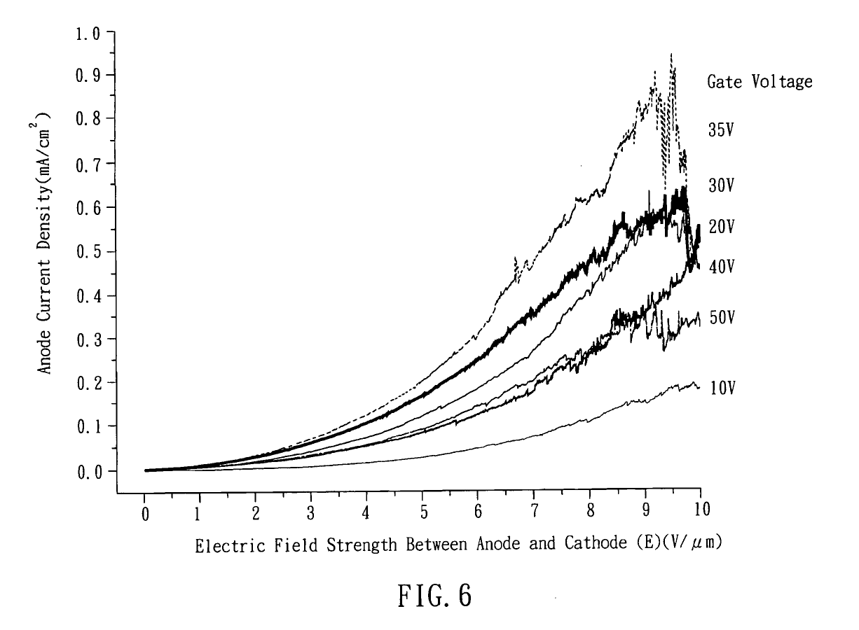

FIG. 6 is a plot of the field emission test result. When the strength of the electric field applied between the two electrode plates is increased, the current density of the electron-emitting source is also greater. Also, as observed from FIG. 6, when the voltage difference between the cathode layer and the anode layer is incrementally increased from 10V to 35V, the field emission effects are observed to greatly increase. However, this applied voltage difference does reach its limitations. That is, if the voltage difference is greater than the load sustainable by the elements, such as by applying a voltage difference of 40V and 50V between cathode layer and gate electrode layer, then most electrons are attracted towards the gate electrode, causing adverse effects.

As described above, the invention can manufacture a DLC with micro-scale film structures that have high aspect ratio that is favorable as electron-emitting source material, applicable in cold cathode emitters such as field emission elements, field emission displays, or flat panel light sources.

Although the present invention has been explained in relation to its preferred embodiment, it is to be understood that many other possible modifications and variations can be made without departing from the spirit and scope of the invention as hereinafter claimed.

What is claimed is:

1. An electron emission source comprising:
a substrate; and
a DLC (Diamond-Like Carbon) film layer with film structures deposited on the surface of the substrate;
wherein the film structures of the DLC film layer are arranged on the surface of the substrate to form a petal pattern, and the lateral height of the film structure is between 0.5 μm and 4.0 μm.

2. The electron emission source as claimed in claim 1, wherein the substrate is constituted of semiconductor material, metal material, insulating material, or glass material.

3. The electron emission source as claimed in claim 1, wherein the film structures are curved film structures, long-strip film structures, or the combination thereof.

4. The electron emission source as claimed in claim 1, wherein the thickness of the film structures lies between 0.005 μm and 0.1 μm.

5. The electron emission source as claimed in claim 4, wherein the thickness of the film structures lies between 0.005 μm and 0.05 μm.

6. The electron emission source as claimed in claim 1, wherein the lateral height of the film structures lies between 0.9 μm and 2.0 μm.

7. An electron-emitting source, comprising:
a substrate;
a conduction layer formed on the surface of the substrate; and
a DLC (Diamond-Like Carbon) film layer with film structures deposited on the surface of the substrate;
wherein the film structures of the DLC film layer are arranged on the surface of the substrate to form a petal pattern, and the lateral height of the film structure is between 0.5 μm and 4.0 μm.

8. The electron-emitting source as claimed in claim 7, wherein the substrate is constituted of semiconductor material, metal material, insulating material, or glass material.

9. The electron-emitting source as claimed in claim 7, wherein the conductive layer is constituted of ITO, zinc oxide, ZTO, metal, or metal alloy.

10. The electron-emitting source as claimed in claim 7, wherein the film structures are curved film structures, long-strip film structures, or the combination thereof.

11. The electron-emitting source as claimed in claim 7, wherein the thickness of the film structures is between 0.005 μm and 0.1 μm.

12. The electron-emitting source as claimed in claim 7, wherein the thickness of the film structures is between 0.005 μm and 0.05 μm.

13. The electron-emitting source as claimed in claim 7, wherein the lateral height of the film structures is between 0.9 μm and 2.0 μm.

14. A field emission display, comprising:
an upper substrate with a phosphor layer and an anode layer; and
a lower substrate with an electron emission layer and a cathode layer, the electron emission layer being adhered closely to the cathode layer;
wherein the electron emission layer comprises a DLC with a plurality of micro-scale film structures arranged on the surface of the substrate forming a petal pattern, the film structures having a lateral height between 0.5 μm and 4.0 μm.

15. The field emission display as claimed in claim 14, wherein the film structures are curved film structures, long-strip film structures, or the combination thereof.

16. The field emission display as claimed in claim 14, wherein the thickness of the film structures is between 0.005 μm and 0.1 μm.

17. The field emission display as claimed in claim 14, wherein the thickness of the film structures is between 0.005 μm and 0.05 μm.

18. The field emission display as claimed in claim 14, wherein the thickness of the film structures is between 0.9 μm and 2.0 μm.

19. The field emission display as claimed in claim 14, further comprising a gate electrode layer disposed between the cathode plate and the anode plate, the gate electrode layer being a plurality of gate electrodes.

20. The field emission display as claimed in claim 14, wherein the upper substrate further comprises a mask layer adhered closely to the phosphor layer.
